(19) United States
(12) Patent Application Publication
(10) Pub. No.: US 2021/0056234 A1
(43) Pub. Date: Feb. 25, 2021

(54) DATA MANAGEMENT APPARATUS FOR SECURELY UPDATING DYNAMIC DATA AND OPERATING METHOD THEREOF

(71) Applicant: ELECTRONICS AND TELECOMMUNICATIONS RESEARCH INSTITUTE, Daejeon (KR)

(72) Inventors: Taek-Young YOUN, Daejeon (KR); Nam-Su JHO, Daejeon (KR); Dae-Sung MOON, Daejeon (KR); Ik-Kyun KIM, Daejeon (KR); Seung-Hun JIN, Daejeon (KR)

(21) Appl. No.: 16/988,134

(22) Filed: Aug. 7, 2020

(30) Foreign Application Priority Data
Aug. 21, 2019 (KR) 10-2019-0102172

(51) Int. Cl. G06F 21/64; H04L 9/32

(52) U.S. Cl. CPC G06F 21/64; H04L 9/3242

(57) ABSTRACT

Disclosed herein is a method of operating a data management apparatus. The method may include segmenting, by a client device, data into multiple data blocks, generating, by the client device, tags corresponding to the multiple data blocks, generating, by the client device, a representative value by accumulating the tags, generating, by the client device, a client signature value by signing the representative value and a counter value corresponding to the last updated data block, among the multiple data blocks, and transmitting, by the client device, the data and the client signature value to a server.

### CROSS REFERENCE TO RELATED APPLICATION

This application claims the benefit of Korean Patent Application No. 10-2019-0102172, filed Aug. 21, 2019, which is hereby incorporated by reference in its entirety into this application.

### BACKGROUND OF THE INVENTION

### 1. Technical Field

The present invention relates to a data management apparatus for securely updating dynamic data and an operating method thereof.

### 2. Description of the Related Art

In the case of storage services, service providers are regarded as organizations having reliability above a certain level, but are assumed to be honest-but-curious attackers. Individual data owners are regarded as general users who entrust their data to a storage server and are not considered attackers. However, in storage services provided for dynamic data, a more powerful form of attacks may be attempted not only by service providers but also by data owners than in a service provided for static data. However, no method for preventing new forms of attacks expected to be attempted in such an environment is known.

### DOCUMENTS OF RELATED ART

(Patent Document 1) U.S. Patent Application Publication US 2008-0134321, published on Jun. 15, 2008 and titled “Tamper-resistant method and apparatus for verification and measurement of host agent dynamic data updates”
(Patent Document 2) Chinese Patent Application Publication No. CN 103279718 B, published on Oct. 21, 2015 and titled “Data integrity verification method based on SBT in cloud storage”.

### SUMMARY OF THE INVENTION

An object of the present invention is to provide a new data management apparatus for responding to malicious threats that can be launched at a storage service for storing dynamic data and a method of operating the new data management apparatus.

Another object of the present invention is to provide a data management apparatus and a method of operating the same that are capable of preventing an attack attempted by a service provider with the aim of reducing service management expenses by neglecting to update stored data and an attack by a data owner on the trust of the service provider, such as falsely claiming that a data update request was made even though no request was actually made.

A further object of the present invention is to provide a data management apparatus and a method of operating the same that prevent a malicious service provider or a malicious user from denying the existence of the most recent version of data in a storage service for storing dynamic data and application services related thereto, thereby preventing the security of the services from being damaged.

Yet another object of the present invention is to provide a data management apparatus and a method of operating the same that prevent a malicious user from denying the existence of the most recent version of data and falsely claiming the previous data to be the most recent version of data and prevent malicious purposes, such as defaming a user's reputation in such a way that a malicious client falsely claims that data that is not actually updated or another version of data is the most recent version, from being achieved.

The technical objects of the present invention are not limited to the above technical objects, and other technical objects that are not mentioned will be readily understood by a person of ordinary skill in the art from the following description.

A method of operating a data management apparatus according to an embodiment of the present invention may include segmenting, by a client device, data into multiple data blocks; generating, by the client device, tags corresponding to the multiple data blocks; generating, by the client device, a representative value by accumulating the tags; generating, by the client device, a client signature value by signing the representative value and a counter value corresponding to a last updated data block, among the multiple data blocks; and transmitting, by the client device, the data and the client signature value to a server.

In an embodiment, individual sizes of the multiple data blocks may be identical to each other.

In an embodiment, at least one of the multiple data blocks may have a different size.

In an embodiment, generating the tags may include generating a hash value for each of the multiple data blocks.

In an embodiment, generating the hash value may include generating the hash value using a key value shared between the client device and the server, the data block, and a counter value corresponding to the data block.

In an embodiment, generating the hash value may include generating the hash value using a key value shared between the client device and the server, the data block, the length of the data block, and a counter value corresponding to the data block.

In an embodiment, the representative value may be updated by adding or subtracting the hash value of a data block, corresponding to a change to dynamic data, to or from the representative value.

In an embodiment, the method may further include receiving, by the client device, a server signature value corresponding to the client signature value.

In an embodiment, the method may further include deleting, by the client device, the data after verifying the server signature value.

In an embodiment, the method may further include storing, by the client device, the server signature value, the representative value, and the counter value.

In an embodiment, the method may further include transmitting, by the client device, a request to update the data to the server.

In an embodiment, the method may further include receiving, by the client device, a new server signature value, corresponding to the request, from the server; verifying, by the client device, the new server signature value; generating, by the client device, a new client signature value by signing an updated representative value and an updated counter value corresponding to the new server signature value after verification of the new server signature value is completed; transmitting, by the client device, the new client signature value to the server; and storing, by the client device, the new server signature value, the updated representative value, and the updated counter value.

A method of operating a data management apparatus according to an embodiment of the present invention may include receiving, by a server, data and a client signature value from a client device; generating, by the server, a representative value corresponding to the data; verifying, by the server, the client signature value using the representative value; generating, by the server, a server signature value by signing a representative value and a counter value corresponding to the client signature value after verification of the client signature value is completed; transmitting, by the server, the server signature value to the client device; and storing, by the server, the data, the client signature value, the representative value, and the counter value.

In an embodiment, the method may further include receiving, by the server, an update request from the client device.

In an embodiment, the method may further include updating, by the server, the representative value and the counter value in response to the update request; generating, by the server, a new server signature value by signing the updated representative value and the updated counter value; and transmitting, by the server, the new server signature value to the client device.

In an embodiment, the method may further include receiving, by the server, a new client signature value corresponding to the new server signature value from the client device; verifying, by the server, the new client signature value; updating, by the server, the data in compliance with the update request after verification of the new client signature value is completed; and storing, by the server, the updated data, the new client signature value, the updated representative value, and the updated counter value.

A data management apparatus according to an embodiment of the present invention may include at least one processor and memory for storing at least one instruction executed by the at least one processor. The at least one instruction may be executed by the at least one processor so as to receive data and a client signature value from a client device, to segment the data into multiple data blocks, to generate tags of the data blocks, to generate a representative value using the generated tags, to verify the client signature value using the representative value, to generate a server signature value by signing a representative value and a counter value corresponding to the client signature value after verification of the client signature value is completed, to transmit the server signature value to the client device, and to store the data, the client signature value, the representative value, and the counter value.

In an embodiment, in response to a request for modification of any one of the multiple data blocks, the representative value may be updated by subtracting a hash value corresponding to the data block to be modified from the representative value and by adding a new hash value thereto, the new hash value may be generated using the data block, the modification of which is requested, and a new counter value, and the counter value may be updated to the new counter value by adding 1 to the counter value.

In an embodiment, in response to a request for addition of a data block in the multiple data blocks, the representative value may be updated by adding an additional hash value, corresponding to the data block to be added, thereto, the additional hash value may be generated using the data block, the addition of which is requested, and a new counter value, and the counter value may be updated to the new counter value by adding 1 to the counter value.

In an embodiment, in response to a request for deletion of any one of the multiple data blocks, the representative value may be updated by subtracting a hash value, corresponding to the data block to be deleted, therefrom, and the counter value may be updated by adding 1 thereto.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a block diagram illustrating a data management apparatus according to an embodiment of the present invention;

FIG. 2 is a view illustrating a process in which verification information for the future update of data is generated from original data in order for a data management apparatus to upload initial data according to an embodiment of the present invention;

FIG. 3 is a ladder diagram illustrating a process in which a data management apparatus uploads initial data according to an embodiment of the present invention;

FIG. 4 is a ladder diagram illustrating the operation of a protocol performed by a client and a server in a process in which a data management apparatus updates data according to an embodiment of the present invention;

FIG. 5 is a view illustrating the process of an operation of modifying information for data management in a data update process according to an embodiment of the present invention; and

FIG. 6 is a view illustrating an electronic device according to an embodiment of the present invention.

### DESCRIPTION OF THE PREFERRED EMBODIMENTS

The present invention will be described in detail below with reference to the accompanying drawings so that those having ordinary knowledge in the technical field to which the present invention pertains can easily practice the present invention.

Because the present invention may be variously changed and may have various embodiments, specific embodiments will be described in detail below with reference to the accompanying drawings. However, it should be understood that the embodiments are not intended to limit the present invention to specific disclosure forms and that they include all changes, equivalents or modifications included in the spirit and scope of the present invention. It will be understood that, although the terms “first,” “second,” etc. may be used herein to describe various elements, these elements are not intended to be limited by these terms. These terms are only used to distinguish one element from another element. For example, a first element could be referred to as a second element without departing from the scope of rights of the present invention. Similarly, a second element could also be referred to as a first element. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Also, the terms used herein are used merely to describe specific embodiments, and are not intended to limit the present invention. A singular expression includes a plural expression unless a description to the contrary is specifically pointed out in context. In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

In a service configured such that private users store their data in remote storage, a variety of methods may be used in order to enable the users to check whether values initially stored by the users are the same as currently stored values. As a representative example of integrity-checking methods, there is a method in which, when data is initially stored, a hash value for the data to be stored or a representative value corresponding thereto is generated and stored, and whether the value is changed is checked later. In addition to the above-described integrity-checking method through static information checking, a method for periodically performing a verification procedure is being researched as a method for verifying the integrity of original data. Representative examples of such a method include Proof of Retrievability (PoR) and Proof of Data Processing (PDP) methods.

These two methods basically share the following operating method. Before a user provides his or her data to a storage server, the user generates information for checking the integrity of the data to be stored based on the original data. In order to check the integrity of the stored data later, a verification procedure in the form of a challenge-response protocol is performed based on the previously generated information. If the procedure is completed successfully, the user may confirm that the data that the user stored in the external storage remains in the original state, but if not, the user may confirm that the service provider has not properly managed the original data.

However, not all security requirements for dynamic data are satisfied by the above-described methods. That is, a method capable of dealing with both a malicious server and a malicious client does not currently exist. Basically, verification based on a fixed value, such as a hash value, is not adequate to provide service for dynamic data. With regard to PoR and PDP methods, there are research results for providing the function of verifying the integrity of dynamic data. However, because users are not considered attackers in the corresponding methods, it is not possible to prevent malicious users (black consumers) from damaging the service.

Conventional methods have limitations in dealing with malicious service providers. The conventional methods provide a function of modifying a value stored in the storage and a value possessed by a user in order to respond to a change in a data configuration in the event of a data update. However, because the conventional methods are based on a framework that does not ensure that information possessed by the two entities is the most recent version, when a server handles a file, the size of which excessively increases during a specific update process, or when stored data is damaged, an attack of pretending that the previous version, which is advantageous to a service provider, is the most recent version may be attempted. That is, because the service provider is assumed to be an honest-but-curious attacker, it may be determined that the service provider can perform malicious behavior when it is impossible to explicitly prove the fault of the service provider. Even if the service provider does not intentionally perform any attack based on this attack scenario, when data is damaged by mistake, the service provider may follow the above course of action in order to avoid responsibility for the damaged data.

As described above, the conventional methods provide the function of updating dynamic data, but the security functions thereof are not sufficient to provide a secure storage service against malicious users or malicious service providers.

A data management apparatus and a method of operating the same according to an embodiment of the present invention may prevent an attack attempted by a service provider with the aim of reducing service management expenses by neglecting to update stored data and an attack by a data owner on the trust of the service provider, such as falsely claiming that a data update request was made even though no request was actually made.

A data management apparatus and a method of operating the same according to an embodiment of the present invention may prevent a malicious service provider or a malicious user from denying the existence of the most recent version of data in a storage service for storing dynamic data and application services related thereto, thereby preventing the security of the services from being damaged.

A data management apparatus and a method of operating the same according to an embodiment of the present invention may prevent a malicious user from denying the existence of the most recent version of data and falsely claiming the previous data to be the most recent version of data, and may prevent malicious purposes, such as defaming a user's reputation in such a way that a malicious client falsely claims that data that is not actually updated or another version of data is the most recent version, from being achieved.

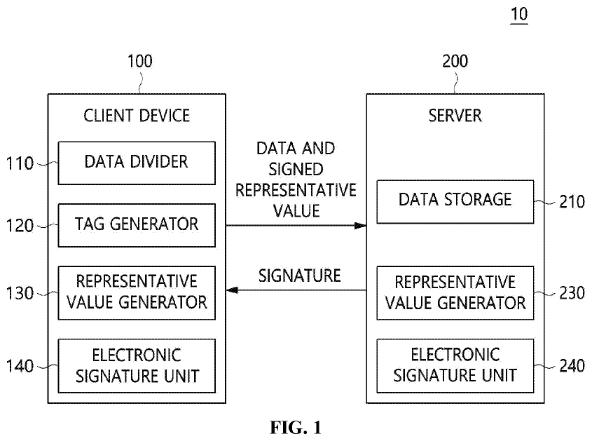

FIG. 1 is a view illustrating a data management apparatus according to an embodiment of the present invention. Referring to FIG. 1, the data management apparatus 10 may include at least one client device 100 and a server 200.

The client device 100 may segment original data into multiple blocks, generate tags corresponding to the respective blocks, generate a representative value using the generated tags, sign the generated representative value with the signature of the client device 100, and transmit the data and a client signature value (the signed representative value) to the server 200.

The client device 100 may include a data divider 110, a tag generator 120, a representative value generator 130, and an electronic signature unit 140.

The data divider 110 may segment original data into multiple blocks. Here, the multiple blocks may have the same size or different sizes. The tag generator 120 may generate a tag corresponding to each of the blocks. According to an embodiment, the tag may be set to a hash value for the block. The representative value generator 130 may generate a representative value corresponding to the original data using the multiple tags. For example, the representative value may be set to a cumulative sum of the multiple tags. The electronic signature unit 140 may sign the representative value with the signature of the client device 100.

The server 200 may receive the data and the client signature value from the client device 100, store the same, verify the client signature value, sign a representative value with the signature of the server 200, and transmit a server signature value to the client device 100. The server 200 may include data storage 210, a representative value generator 230, and an electronic signature unit 240.

The data storage 210 may store data and additional information related thereto (e.g., a client signature value, a representative value, a counter value, and the like), which are received from the client device 100. The representative value generator 230 may generate a representative value corresponding to the data based on a predetermined method. The electronic signature unit 240 may sign a value corresponding to the representative value with the signature of the server.

The data management apparatus 10 according to an embodiment of the present invention generates a representative value for dynamic data when the dynamic data is updated, and uses a signature for the generated representative value, thereby implementing nonrepudiation at low cost. Here, the generated representative value may be easily updated depending on the change to the dynamic data.

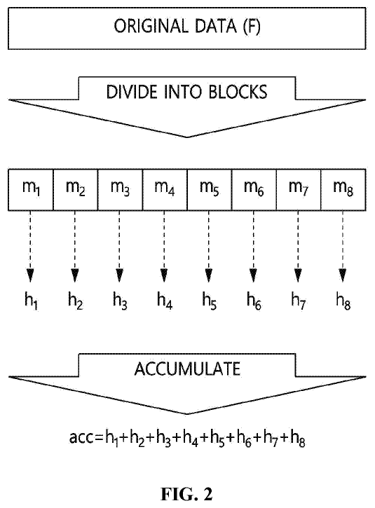

FIG. 2 is a view illustrating a process in which verification information for the future update is generated from original data in order to upload the initial data according to an embodiment of the present invention. Referring to FIG. 2, the client device 100 that intends to store data and the server 200 may calculate information extracted from the original data when the initial data is stored.

The original data file F may be segmented into multiple blocks. The sizes of the blocks are not limited. For example, the respective blocks may have different sizes. Accordingly, an update in units of bits may be provided, rather than an update in units of a fixed size. In this case, data is divided by the same block size at the outset before being stored, and information about the current length of each block may be additionally stored, unlike the case where an update is performed in units of a fixed length.

After segmentation into the multiple blocks, hash values may be calculated for the respective blocks in order to generate tags. In an embodiment, a hash value hᵢ for each of the blocks may be sequentially generated using block data mᵢ and a counter value ctrᵢ as inputs (hᵢ=hash (k, mᵢ∥ctrᵢ)) according to the sequence from 1 to the number of blocks. In an embodiment, when the lengths of the blocks are changeable, the length of each of the blocks may be additionally used as an input when the hash value (hᵢ=hash (k, mᵢ∥lengthᵢ∥ctrᵢ)) is calculated.

In an embodiment, in order to provide independence of each piece of data, a keyed hash using a key may be used. Here, it is assumed that the client device 100 and the server 200 generate a secret key and share the same therebetween using a well-known key exchange method. Meanwhile, the method of generating tags in the present invention is not limited to the keyed hash. For example, when a keyed hash is not used, a simple hash value may be calculated for the same input and may then be used.

Finally, the sum of all of the hash values generated for the respective blocks is calculated, whereby a representative value (acc=h₁+h₂+h₃+h₄+h₅+h₆+h₇+h₈) may be generated. The representative value acc is a value that represents all the data.

That is, in the initialization process of the data management apparatus 10 according to an embodiment of the present invention, a representative value acc and a final data counter value may be generated as final output information pertaining to data F. When blocks are allowed to have different lengths, the length of the block may also be managed along with the counter value.

The data management apparatus 10 according to an embodiment of the present invention is configured such that a service provider and a data owner exchange information, through which a function of nonrepudiation of the most recent version of data is provided, with each other in a storage service environment for dynamic data, so that no one can deny the existence of the most recent version of data and claim another version to be the most recent version, whereby the security of dynamic data configuration management may be improved.

Also, the data management apparatus 10 according to an embodiment may solve a problem in which the use of a nonrepudiation method, such as a signature method, incurs high expenses for generating a signature for all data even when only a portion of data is updated, and may provide technology that enables the expenses for updating data to be proportional to the extent of the update.

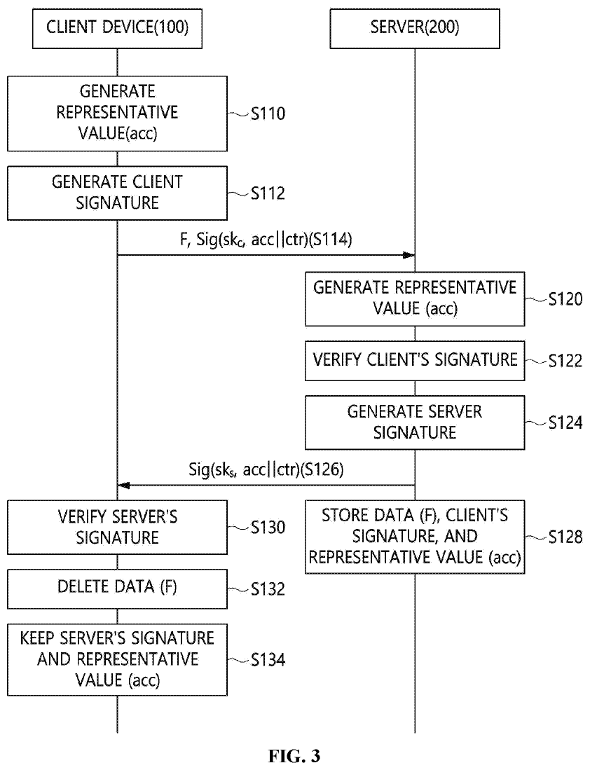

FIG. 3 is a ladder diagram illustrating the operation of an initial data upload protocol performed by a data management apparatus 10 according to an embodiment of the present invention. Referring to FIGS. 1 to 3, the process of uploading initial data may be performed as follows.

The client device 100 may generate a representative value acc for the data F to be stored. Here, the representative value acc may be generated at step S110 using the method described with reference to FIG. 2. Also, the client device 100 may generate a signature for the representative value acc and the final data counter value ctr, which corresponds to the current data version, using the signature key sk_{c} thereof at step S112. Meanwhile, the signing method that is used is not limited to this method.

Then, the client device 100 may transmit the data F and the signature value for the representative value acc of the data F and the counter value ctr (Sig (sk_{c}, acc∥ctr)) to the server 200 at step S114, as shown in FIG. 3.

The server 200 may generate a representative value acc for the data F received from the client device 100 at step S120. Then, the server 200 may verify the signature value (Sig (sk_{c}, acc∥ctr)), which is received from the client device 100, based on the representative value acc at step S122.

When the client signature is valid, the server 200 may generate a signature value of the server 200 (Sig (sk_{c}, acc∥ctr)) for the same values at step S124. Then, the server 200 may transmit the server signature value (Sig (skₛ, acc∥ctr)) to the client device 100 at step S126.

Then, the server 200 may store the data F, the representative value acc, and the counter value ctr (with the last used index, 8). Meanwhile, the counter value ctr is 8 in the example illustrated in FIG. 2. However, the last counter value ctr is not limited thereto.

Then, the client device 100 may receive the server signature value (Sig (skₛ, acc∥ctr)) from the server 200 and verify the same at step S130. When verification of the server signature is successfully completed, the client device 100 may delete the original data F at step S132. That is, the client device 100 may delete the data F possessed thereby from the local memory thereof after it confirms that the information intended to be stored in the server 200 is properly stored in the server 200. Then, the client device 100 may store the signature value of the server 200 (Sig (skₛ, acc∥ctr)), the representative value acc, and the counter value ctr (with the last used index, 8) at step S134.

Meanwhile, a description of the length of each block is omitted, but the length of a block may be checked by default in the course of processing all of the blocks. The information about the length of each block may be finally stored and managed by the server 200, which is supposed to store and manage the data F.

Meanwhile, the representative value according to an embodiment of the present invention may be easily updated in response to a change to the dynamic data.

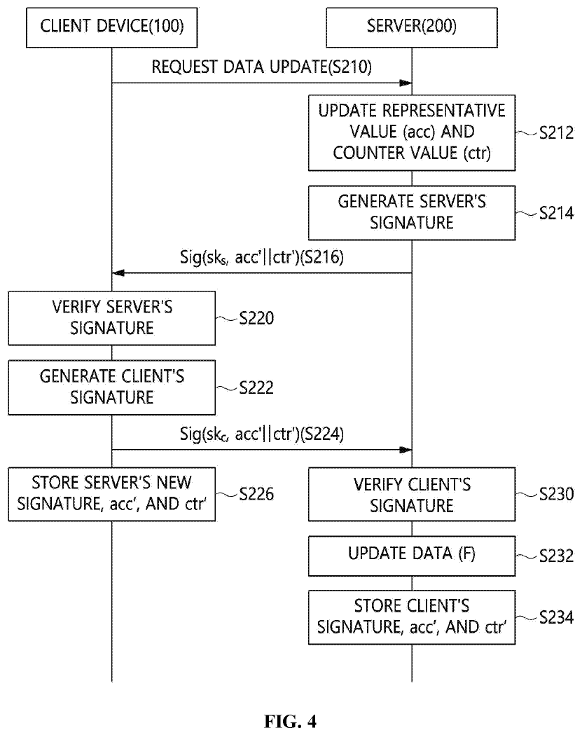

FIG. 4 is a ladder diagram illustrating a process in which a data management apparatus 10 updates data according to an embodiment of the present invention. Referring to FIGS. 1 to 4, the operation of a protocol based on which the client device 100 and the server 200 update data F may be performed as follows.

In the event of an update in the stored data F, the client device 100 may request a change to the data stored in the server based on the update details at step S210.

The server 200 may receive the data update request, and may update the representative value acc and the counter value ctr at step S212 in response to the data update request. The server 200 may generate a server signature value (Sig (skₛ, acc′∥ctr′)) for the two updated values acc′ and ctr′ at step S214. Then, the server 200 may transmit the server signature value (Sig (skₛ, acc′∥ctr′)) to the client device 100 at step S216.

The client device 100 may verify the server signature value (Sig (skₛ, acc′∥ctr′)), which is received from the server 200, at step S220. When the server signature value is verified to be valid, the client device 100 may check whether the update is properly applied in compliance with the update request through the values acc′ and ctr′. When it is confirmed that the update is properly applied, the client device 100 may generate a client signature value (Sig (sk_{c}, acc′∥ctr′)) for the same values at step S222 and transmit the same to the server 200 at step S224. The client device 100 may store the new server signature value (Sig (skₛ, acc′∥ctr′)) and the state information acc′ and ctr′ at step S226.

Then, the server 200 may verify the client signature value (Sig (sk_{c}, acc′∥ctr′)) received from the client device 100 at step S230. When the changes processed by the server 200 in response to the update request from the client device 100 are accepted as being correct, the server 200 may apply the requested update to the actual data at step S232.

When the above-described protocol operation is finished, the server 200 may store the new signature value of the client device 100 (Sig (sk_{c}, acc′∥ctr′)) and the state information acc′ and ctr′ at step S234.

Meanwhile, when the length of the block is changed during the update process, checking the length and the update of the modified information may be performed in the same manner as the method of modifying and updating other information.

As described above, the representative value may be easily updated in response to a change in the dynamic data.

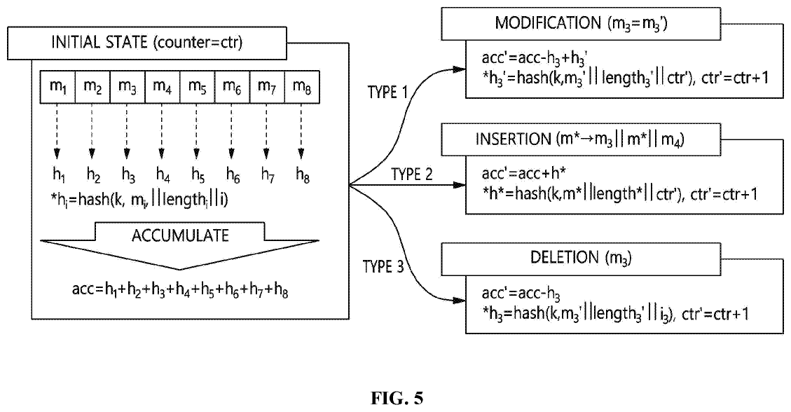

FIG. 5 is a view illustrating an operation performed by the data management apparatus 10 in order to change information for data management during a data update process according to an embodiment of the present invention. Referring to FIGS. 1 to 5, when data is updated, the process of updating information for data management may be performed as follows.

Generally, with regard to dynamic data, three types of data updates, namely modification, insertion, and deletion of a unit block may be requested. Hereinbelow, management information that is updated in response to each request will be described.

When data modification is requested (TYPE 1), the stored representative value acc may be updated to a new representative value acc′ in such a way that the hash value for the old data is subtracted from the stored representative value acc and a hash value for the new data block is added thereto.

For example, as shown in FIG. 5, when the third data block m₃ is modified to a new data block m₃′, the updated representative value acc′ may be calculated as acc−h₃+h₃′. Here, h₃′ is calculated through hash (k, m₃′∥length₃′∥ctr′) and ctr′ is calculated as ctr+1.

When data is added (TYPE 2), a new state number acquired in response to the input of a hash value may be used along with a new data block. When data is added, management information may be updated in such a way that a hash value for the newly added data is generated and is then added to the representative value. As in the case of data modification, the new state number acquired in response to the input of the hash value for the added data may be used along with the new data block.

For example, when a new data block m* is added between the third data block m₃ and the fourth data block m₄, the updated representative value acc′ may be calculated as acc+h*. Here, h* is calculated through hash (k, m*∥length*∥ctr′) and ctr′ is calculated as ctr+1.

When data is deleted (TYPE 3), an operation in which the hash value for the deleted data block is subtracted from the representative value acc may be performed. Here, the state number may be updated by being incremented by 1.

For example, when the third data block m₃ is deleted, the updated representative value acc′ may be calculated as acc−h₃. Here, h_{3′} is calculated through hash (k, m₃′∥length₃′∥i₃) and ctr′ is calculated as ctr+1.

The data management apparatus according to an embodiment of the present invention manages the representative value and the state number so as to be updated in response to modification, insertion, or deletion of a data block, thereby ensuring integrity and managing dynamic data at low cost.

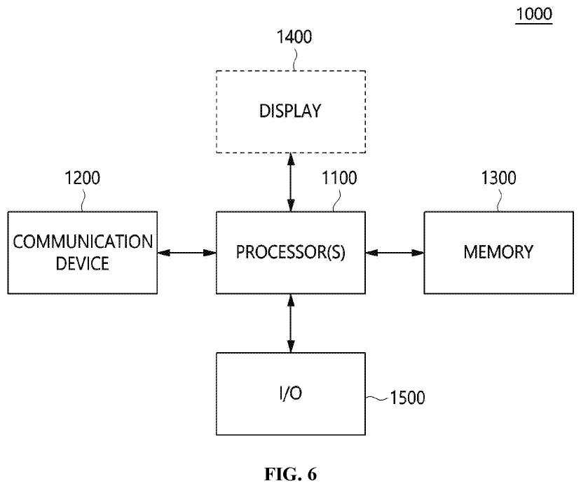

FIG. 6 is a view illustrating an electronic device 1000 according to an embodiment of the present invention. Referring to FIG. 6, the electronic device 1000 may include at least one processor 1100, a network interface 1200, memory 1300, a display 1400, and an I/O device 1500. The electronic device 1000 may be implemented as the client device 100 of the above-described data management apparatus 10 or the server 200 thereof.

The processor 1100 may include at least one of the devices described with reference to FIGS. 1 to 5, or may be implemented using at least one of the methods described with reference to FIGS. 1 to 5.

When the electronic device 1000 is implemented as the server 200, the processor 1100 may execute instructions so as to receive data and a client signature value from the client device, to segment the data into multiple data blocks, to generate tags of the data blocks, to generate a representative value using the generated tags, to verify the client signature value using the representative value, to generate a server signature value by signing the representative value and the counter value corresponding to the client signature value after completion of verification of the client signature value, to transmit the server signature value to the client device, and to store the data, the client signature value, the representative value, and the counter value, as described above.

In an embodiment, in response to a request to modify any one of the multiple data blocks, the representative value may be updated by subtracting the hash value of the data block to be modified from the representative value and adding a new hash value thereto. The new hash value may be generated using the data block, the modification of which is requested, and a new counter value. The counter value may be updated to the new counter value by adding 1 thereto. In an embodiment, in response to a request to add a data block in the multiple data blocks, the representative value may be updated by adding an additional hash value, corresponding to the data block to be added, thereto. The additional hash value may be generated using the data block, the addition of which is requested, and a new counter value. The counter value may be updated to the new counter value by adding 1 thereto. In an embodiment, in response to a request to delete any one of the multiple data blocks, the representative value may be updated by subtracting the hash value, corresponding to the block to be deleted, from the representative value, and the counter value may be updated by adding 1 thereto.

The processor 1100 may run programs and control the electronic device 1000. The electronic device 1000 may be connected with an external device (e.g., a personal computer or a network) and may exchange data therewith via the I/O devices 1500.

The network interface 1200 may be implemented so as to communicate with an external network using any of various wired/wireless methods.

The memory 1300 may store computer-readable instructions. The processor 1100 may perform the above-described operations by executing the instructions stored in the memory 1300. The memory 1300 may be volatile or nonvolatile memory. The memory 1300 may include a storage device for storing user data. The storage device may be an embedded multimedia card (eMMC), a solid-state drive (SSD), universal flash storage (UFS), or the like. The storage device may include at least one nonvolatile memory device. The nonvolatile memory device may be any of NAND flash memory, Vertical NAND (VNAND), NOR flash memory, Resistive Random-Access Memory (RRAM), Phase-Change Memory (PRAM), Magnetoresistive Random-Access Memory (MRAM), Ferroelectric Random-Access Memory (FRAM), Spin-Transfer-Torque Random-Access Memory (STT-RAM), and the like.

The embodiments described above may be implemented through hardware components, software components, and/or combinations thereof. For example, the apparatus, method and components described in the embodiments may be implemented using one or more general-purpose computers or special-purpose computers, for example, a processor, a controller, an arithmetic logic unit (ALU), a digital signal processor, a microcomputer, a field-programmable gate array (FPGA), a programmable logic unit (PLU), a microprocessor, or any other device capable of executing instructions and responding thereto. The processing device may run an operating system (OS) and one or more software applications executed on the OS.

Also, the processing device may access, store, manipulate, process and create data in response to execution of the software. For the convenience of description, the processing device is described as a single device, but those having ordinary skill in the art will understand that the processing device may include multiple processing elements and/or multiple forms of processing elements. For example, the processing device may include multiple processors or a single processor and a single controller. Also, other processing configurations such as parallel processors may be available.

The software may include a computer program, code, instructions, or a combination thereof, and may configure a processing device to be operated as desired, or may independently or collectively instruct the processing device to be operated. The software and/or data may be permanently or temporarily embodied in a specific form of machines, components, physical equipment, virtual equipment, computer storage media or devices, or transmitted signal waves in order to be interpreted by a processing device or to provide instructions or data to the processing device. The software may be distributed across computer systems connected with each other via a network, and may be stored or run in a distributed manner. The software and data may be stored in one or more computer-readable storage media.

The method according to the embodiments may be implemented as program instructions executable by various computer devices, and may be recorded in computer-readable storage media. The computer-readable storage media may individually or collectively include program instructions, data files, data structures, and the like. The program instructions recorded in the media may be specially designed and configured for the embodiment, or may be readily available and well known to computer software experts. Examples of the computer-readable storage media include magnetic media such as a hard disk, a floppy disk and a magnetic tape, optical media such as a CD-ROM and a DVD, and magneto-optical media such as a floptical disk, ROM, RAM, flash memory, and the like, that is, a hardware device specially configured for storing and executing program instructions. Examples of the program instructions include not only machine code made by a compiler but also high-level language code executable by a computer using an interpreter or the like. The above-mentioned hardware device may be configured so as to operate as one or more software modules in order to perform the operations of the embodiment and vice-versa.

The present invention is technology for responding to all of attacks attempted by a malicious client and a malicious server in an environment configured to store data in external storage. Unlike conventional approaches, it is theoretically possible to ensure security even when a client conducts malicious behavior as a black consumer. Also, in consideration of the fact that, when dynamically changed data is handled, a server is also more likely to perform malicious behavior than in the existing security model, the present invention provides technology for responding thereto. From the aspect of realization of such functions, a method capable of overcoming the technical limitations of an approach in which the two parties involved generate their respective signatures and exchange the same whenever data is updated may be provided. More specifically, the present invention provides a technical basis for overcoming the disadvantage in which a signature is calculated for all data whenever an update event occurs. Actually, the greater the size of data, the greater the burden imposed for updating the data. The burden may increase in proportion to the size of the entire data.

The technology provided by the present invention is for providing a secure data update function with expenses in proportion to the size of the portion of data to be updated, rather than the total size of data.

A data management apparatus and a method of operating the same according to an embodiment of the present invention are configured such that a service provider and a data owner exchange information, through which a function of nonrepudiation of the most recent version of data is provided, with each other in a storage service environment for dynamic data, so that no one can deny the existence of the most recent version of data and claim another version to be the most recent version, whereby the security of dynamic data configuration management may be improved.

Also, through a data management apparatus and a method of operating the same according to an embodiment of the present invention, there may be provided technology that enables expenses for updating data to be kept proportional to the extent of the update without causing a problem in which the use of a nonrepudiation method, such as a signature method, incurs high expenses for generating a signature for all data even when only a portion of data is updated.

Meanwhile, the above description is merely of specific embodiments for practicing the present invention. The present invention encompasses not only concrete and currently available means but also the technical spirit corresponding to abstract and conceptual ideas that may be used as future technology.

What is claimed is:

1. A method of operating a data management apparatus, comprising:
segmenting, by a client device, data into multiple data blocks;
generating, by the client device, tags corresponding to the multiple data blocks;
generating, by the client device, a representative value by accumulating the tags;
generating, by the client device, a client signature value by signing the representative value and a counter value corresponding to a last updated data block, among the multiple data blocks; and
transmitting, by the client device, the data and the client signature value to a server.

2. The method of claim 1, wherein individual sizes of the multiple data blocks are identical to each other.

3. The method of claim 1, wherein at least one of the multiple data blocks has a different size.

4. The method of claim 1, wherein generating the tags comprises:
generating a hash value for each of the multiple data blocks.

5. The method of claim 4, wherein generating the hash value comprises:
generating the hash value using a key value shared between the client device and the server, the data block, and a counter value corresponding to the data block.

6. The method of claim 4, wherein generating the hash value comprises:
generating the hash value using a key value shared between the client device and the server, the data block, a length of the data block, and a counter value corresponding to the data block.

7. The method of claim 4, wherein the representative value is updated by adding or subtracting a hash value of a data block, corresponding to a change to dynamic data, to or from the representative value.

8. The method of claim 1, further comprising:
receiving, by the client device, a server signature value corresponding to the client signature value.

9. The method of claim 8, further comprising:
deleting, by the client device, the data after verifying the server signature value.

10. The method of claim 9, further comprising:
storing, by the client device, the server signature value, the representative value, and the counter value.

11. The method of claim 1, further comprising:
transmitting, by the client device, a request to update the data to the server.

12. The method of claim 11, further comprising:
receiving, by the client device, a new server signature value, corresponding to the request, from the server;
verifying, by the client device, the new server signature value;
generating, by the client device, a new client signature value by signing an updated representative value and an updated counter value corresponding to the new server signature value after verification of the new server signature value is completed;
transmitting, by the client device, the new client signature value to the server; and
storing, by the client device, the new server signature value, the updated representative value, and the updated counter value.

13. A method of operating a data management apparatus, comprising:
receiving, by a server, data and a client signature value from a client device;
generating, by the server, a representative value corresponding to the data;
verifying, by the server, the client signature value using the representative value;
generating, by the server, a server signature value by signing a representative value and a counter value corresponding to the client signature value after verification of the client signature value is completed;
transmitting, by the server, the server signature value to the client device; and
storing, by the server, the data, the client signature value, the representative value, and the counter value.

14. The method of claim 13, further comprising:
receiving, by the server, an update request from the client device.

15. The method of claim 14, further comprising:
updating, by the server, the representative value and the counter value in response to the update request;
generating, by the server, a new server signature value by signing the updated representative value and the updated counter value; and
transmitting, by the server, the new server signature value to the client device.

16. The method of claim 15, further comprising:
receiving, by the server, a new client signature value corresponding to the new server signature value from the client device;
verifying, by the server, the new client signature value;
updating, by the server, the data in compliance with the update request after verification of the new client signature value is completed; and
storing, by the server, the updated data, the new client signature value, the updated representative value, and the updated counter value.

17. A data management apparatus, comprising:
at least one processor; and
memory for storing at least one instruction executed by the at least one processor,
wherein the at least one instruction is executed by the at least one processor so as to receive data and a client signature value from a client device, to segment the data into multiple data blocks, to generate tags of the data blocks, to generate a representative value using the generated tags, to verify the client signature value using the representative value, to generate a server signature value by signing a representative value and a counter value corresponding to the client signature value after verification of the client signature value is completed, to transmit the server signature value to the client device, and to store the data, the client signature value, the representative value, and the counter value.

18. The data management apparatus of claim 17, wherein:
in response to a request for modification of any one of the multiple data blocks, the representative value is updated by subtracting a hash value corresponding to the data block to be modified from the representative value and by adding a new hash value thereto,
the new hash value is generated using the data block, the modification of which is requested, and a new counter value, and
the counter value is updated to the new counter value by adding 1 to the counter value.

19. The data management apparatus of claim 17, wherein:
in response to a request for addition of a data block in the multiple data blocks, the representative value is updated by adding an additional hash value, corresponding to the data block to be added, thereto,
the additional hash value is generated using the data block, the addition of which is requested, and a new counter value, and
the counter value is updated to the new counter value by adding 1 to the counter value.

20. The data management apparatus of claim 17, wherein:
in response to a request for deletion of any one of the multiple data blocks, the representative value is updated by subtracting a hash value, corresponding to the data block to be deleted, therefrom, and
the counter value is updated by adding 1 thereto.
